(19) United States
(12) Patent Application Publication
(10) Pub. No.: US 2005/0196001 A1
(43) Pub. Date: Sep. 8, 2005

(54) Hearing aid employing electret and silicon microphones

(75) Inventors: Uwe Rass, Nurnberg (DE); Christian Weistenhofer, Bubenreuth (DE)

Correspondence Address: SCHIFF HARDIN LLP;Patent Department, 6600 Sears Tower, 233 South Wacker Drive, Chicago, IL, 60606, US

(73) Assignee: Siemens Audiologische Technik GmbH

(21) Appl. No.: 11/073,044

(22) Filed: Mar. 3, 2005

(30) Foreign Application Priority Data
Mar. 5, 2004 (DE) 10 2004 010 863.3

(51) Int. Cl. H04R 25/00

(52) U.S. Cl. 381/313; 381/312

(57) ABSTRACT

In a hearing device with multiple microphones, and a signal generation method, the dynamic range of hearing devices is improved by using a combination including a silicon microphone and an electret microphone for the hearing device input. Low frequencies thus can be acquired by the silicon microphone and high frequencies can be acquired by the electret microphone, in order to generate a wide-band hearing device input signal. The fact that a silicon microphone possesses a lower internal noise than a conventional electret microphone at low frequencies is utilized.

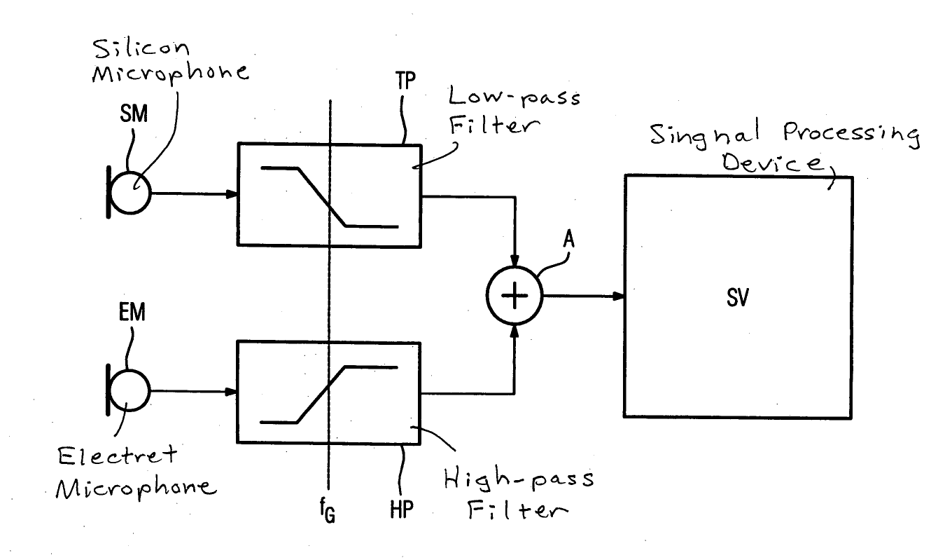

### BACKGROUND OF THE INVENTION

1. Field of the Invention

The present invention concerns a hearing device of the type having a first microphone that delivers a first microphone signal, a second microphone that delivers a second microphone signal, and a signal processing device to generate a hearing device output signal from the first microphone signal and the second microphone signal. The present invention also concerns a corresponding method for generating a hearing device output signal.

2. Description of the Prior Art and Related Subject Matter

The internal (quantum) noise of the microphones in hearing devices limits the dynamic range, in particular when differential directional microphonal algorithms are used. These algorithms have the result that the noise of the microphones is notably boosted at low frequencies. The higher the selected order of the directional microphone, the more serious this effect because (as is known) the transfer function of a directional microphone of the second order with three microphones drops at low frequencies faster than the transfer function of a directional microphone of the first order with two microphones. Given a directional microphone of the second order, the low frequencies consequently must be more emphasized than the low frequencies in a directional microphone of the first order, such that the signal-to-noise ratio at low frequencies is disadvantageous for a directional microphone of the second order.

Heretofore, the directional effect for low frequencies has been limited, as described, for example in “Three microphone instrument is designed to extend benefits of directionality”, The Hearing Journal, October 2002, vol. 55, nr. 10, pages 38 through 45. Below a specific limit frequency, only a directional microphone of the first order is used, and for high frequencies a directional microphone of the second order is used.

The damping of the interfering signals that do not originate from the preferred direction is also less for low frequencies. In order to reduce the noise for the hearing device user, given quiet input levels the directional effect is therefore completely removed, such that the noise caused by one directional microphone ceases to exist. In this case, the microphone characteristic corresponds to an omnidirectional microphone.

A directional microphone system for hearing devices is known from the German Patent 103 16 287. Such a microphone system can be based on silicon micro-mechanisms. An electret capacitor microphone could alternatively be used.

### SUMMARY OF THE INVENTION

An object of the present invention is to provide a hearing device having a directional effect in the low-frequency range with reduced noise, and as well as to provide a corresponding method to generate a hearing device output signal.

This object is inventively achieved by a hearing device with a first microphone device that delivers a first microphone signal, a second microphone device that delivers a second microphone signal, and a signal processing device that generates a hearing device output signal, wherein the first microphone device comprises an electret microphone and the second microphone device comprises a silicon microphone.

The advantageous noise ratio of the silicon microphone at low frequencies allows a better directional effect (higher directivity index) with the same noise. Expressed otherwise, it leads to a lower noise with the same directional effect. The signal quality at higher frequencies is not influenced because the conventional electret microphone is used for signal acquisition in this range.

In an embodiment of the inventive hearing device, the output of the first microphone is high-pass filtered, preferably by a high-pass filter connected immediately downstream. The microphone noise of the electret microphone at low frequencies is suppressed in this manner.

In another embodiment, the output of the second microphone device is low-pass filtered, preferably by a low-pass filter connected immediately downstream of the second microphone device. The less-positive transfer characteristic of the silicon microphone is thereby masked or suppressed.

The signal-processing device can include an adder with which the (possibly filtered) microphone signals are added. Both microphone signals can be combined in a relatively simple manner in this manner. Moreover, the signal processing device for the first microphone signal and the second microphone signal can include analog-to-digital converters respectively for the two microphone signals such that both microphone signals can be digitally combined with one another. The advantages of digital signal processing thus can be used.

In a preferred embodiment, the first microphone device comprises at least two electret microphones. Directional microphones of the first order with two electret microphones, directional microphones of the second order with three electret microphones, etc. can thus be realized for the higher-pitch (treble) range.

The second microphone device can comprise at least two silicon microphones in the same manner. Directional microphones of the first order, second order etc. can therewith be realized for the lower-pitch (bass) range.

### DESCRIPTION OF THE DRAWING

The single FIGURE is a circuit diagram of an inventive hearing device.

### DESCRIPTION OF THE PREFERRED EMBODIMENTS

The exemplary embodiments described in the following represent preferred embodiments of the present invention.

The basic signal input components of an inventive hearing device are drawn in the FIGURE. The hearing device has a silicon microphone SM and an electret microphone EM. The output signal of the silicon microphone SM is supplied to a low-pass filter TP. The output signal of the electret microphone EM is delivered on its end into a high-pass filter HP. The limit frequency f_{G} of both filters TP and HP is selected approximately equally high, such that in a first approximation a transfer function designed flat for both filters mutually results in the sum. Both output signals of the filters TP and HP are added in an adder A. The sum signal of the adder A is supplied to the further hearing device signal processing SV.

With this design, the fact is utilized that silicon microphones possess a low internal noise at low frequencies but they perform worse than conventional electret microphones at higher frequencies. The combination of the two microphone types enables the low frequencies to be acquired by the silicon microphone SM and the high frequencies to be acquired by the electret microphone in order to generate a wide-band hearing device input signal for the signal processing SV. The combination can analogously ensue in the form of a diplexer or can be realized digitally. Corresponding analog-digital converters are additionally necessary for digital signal processing.

In order to realize a directional microphone of the first or second order, two or three such combined silicon-electret microphones, respectively including high-pass and low-pass filters as well as adders, are necessary.

Although modifications and changes may be suggested by those skilled in the art, it is the intention of the inventors to embody within the patent warranted hereon all changes and modifications as reasonably and properly come within the scope of their contribution to the art.

1. A hearing device comprising:
a first microphone device that delivers a first microphone signal, said first microphone device comprising an electret microphone;
a second microphone device that delivers a second microphone signal, said second microphone device comprising a silicon microphone; and
a signal processing device that generates a hearing device output signal from said first microphone signal and said second microphone signal.

2. A hearing device as claimed in claim 1 comprising a high pass filter connected immediately downstream from said first microphone device.

3. A hearing device as claimed in claim 1 comprising a low pass filter connected immediately downstream from said second microphone device.

4. A hearing device as claimed in claim 1 wherein said signal processing device comprises an adder for adding said first microphone signal and said second microphone signal.

5. A hearing device as claimed in claim 1 wherein said signal processing device comprises a first analog-to-digital converter to which said first microphone signal is supplied, that emits a first digital signal, and a second analog-to-digital converter to which said second microphone signal is supplied, that emits a second digital signal, and wherein said signal processing device combines said first digital signal and said second digital signal to produce said hearing device output signal.

6. A hearing device as claimed in claim 1 wherein said first microphone device comprises at least two electret microphones.

7. A hearing device as claimed in claim 1 wherein said second microphone device comprises at least two silicon microphones.
